(19) United States
(12) Patent Application Publication
(10) Pub. No.: US 2011/0306253 A1
(43) Pub. Date: Dec. 15, 2011

(54) ELECTRONIC CONNECTOR

(75) Inventors: Tadashi KUMAMOTO, Tokyo (JP); Takeshi OKUYAMA, Tokyo (JP); Kazuhiro MIZUKAMI, Tokyo (JP); Toshihiro KUSAGAYA, Tokyo (JP)

(73) Assignee: FUJITSU COMPONENT LIMITED

(21) Appl. No.: 13/152,488

(22) Filed: Jun. 3, 2011

(30) Foreign Application Priority Data
Jun. 11, 2010 (JP) 2010-134029

(51) Int. Cl. H01R 13/46

(52) U.S. Cl. 439/892

(57) ABSTRACT

An electronic connector includes a connector body which is fixed to a board and to be connected to another connector; a cage which is formed by die-casting a metal and shaped to cover entire side surfaces of the connector body and the other connector; and a pressure cover which includes fixed terminals for fixing the pressure cover to the board, wherein the pressure cover is connected to the cage, and the cage is connected to the board by the fixed terminals of the pressure cover.

### CROSS-REFERENCE TO RELATED APPLICATIONS

This patent application is based upon and claims the benefit of priority of the prior Japanese Patent Application No. 2010-134029 filed on Jun. 11, 2010, the entire contents of which are incorporated herein by reference.

### FIELD

A certain aspect of the embodiments discussed herein is related to an electronic connector.

### BACKGROUND

An electronic connector is a member for electronically connecting an electronic device, an electronic apparatus or the like and transmitting an electronic signal or the like. There are various types of electronic connectors depending on uses. The electronic connectors are selected depending on the uses. For example, in order to transmit a high-frequency signal, there is a connector for high-frequencies.

U.S. Laid-open Patent Publication No. 2002-0025720 discloses a high-frequency connector having a structure of a cage to handle Electromagnetic interference (EMI). The connector is fixed to a board by a terminal provided in the cage.

### SUMMARY

According to an aspect of the embodiment, an electronic connector includes a connector body which is fixed to a board and is configured to be connected to another connector; a cage which is formed by die-casting a metal and shaped to cover entire side surfaces of the connector body and the other connector; and a pressure cover which includes fixed terminals for fixing the pressure cover to the board, wherein the pressure cover is connected to the cage, and the cage is connected to the board by the fixed terminals of the pressure cover.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1A illustrates an electronic connector of an embodiment;

FIG. 1B is an explanatory view of electronic connectors of the embodiment;

FIG. 2 illustrates a connected state of the electronic connectors of the embodiment;

FIG. 3 is a cross-sectional view of the connected electronic connectors of the embodiment;

FIG. 4A illustrates a pressure cover of an electronic connector of the embodiment;

FIG. 4B illustrates the pressure cover of another electronic connector of the embodiment;

FIG. 5 is a perspective view of electronic connectors mounted on both sides of a board;

FIG. 6 is a side view of the electronic connectors mounted on both surfaces (double sides) of the board;

FIG. 7 is an explanatory view of a board on a single side of which an electronic connector is mounted; and

FIG. 8 is an explanatory view of a board on both surfaces of which electronic connectors are mounted.

### DESCRIPTION OF EMBODIMENT

A method of inserting a terminal provided in the cage or the like into through-holes formed in a board and fixing the terminals or the like to the board is generally employed as a method of fixing the cage.

However, because the cage is ordinarily formed by a thin metal plate substantially covering the electric connector in its entirety, in a case where an electronic connector to be inserted is directly connected to a cable or the like, the connector might be pulled by the cable thereby causing the electronic connector to be deformed or loosened. Thus, the electronic connector fixed to the board might break away from the board and a contact failure may occur.

Preferred embodiments of the present invention will be explained with reference to accompanying drawing.

### (Structure of an Electronic Connector)

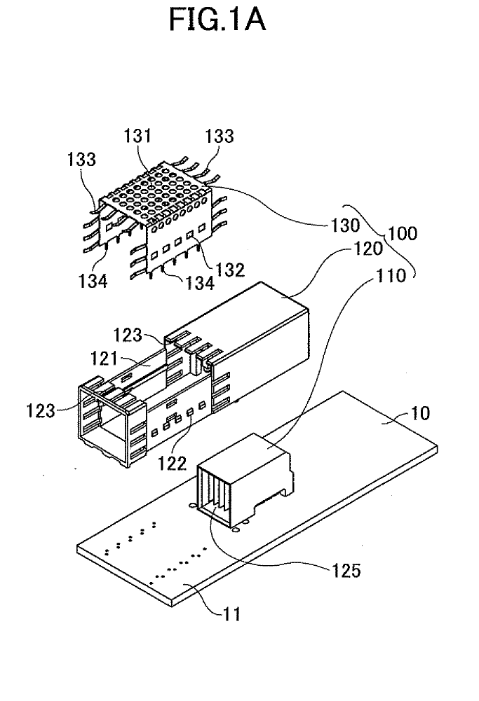

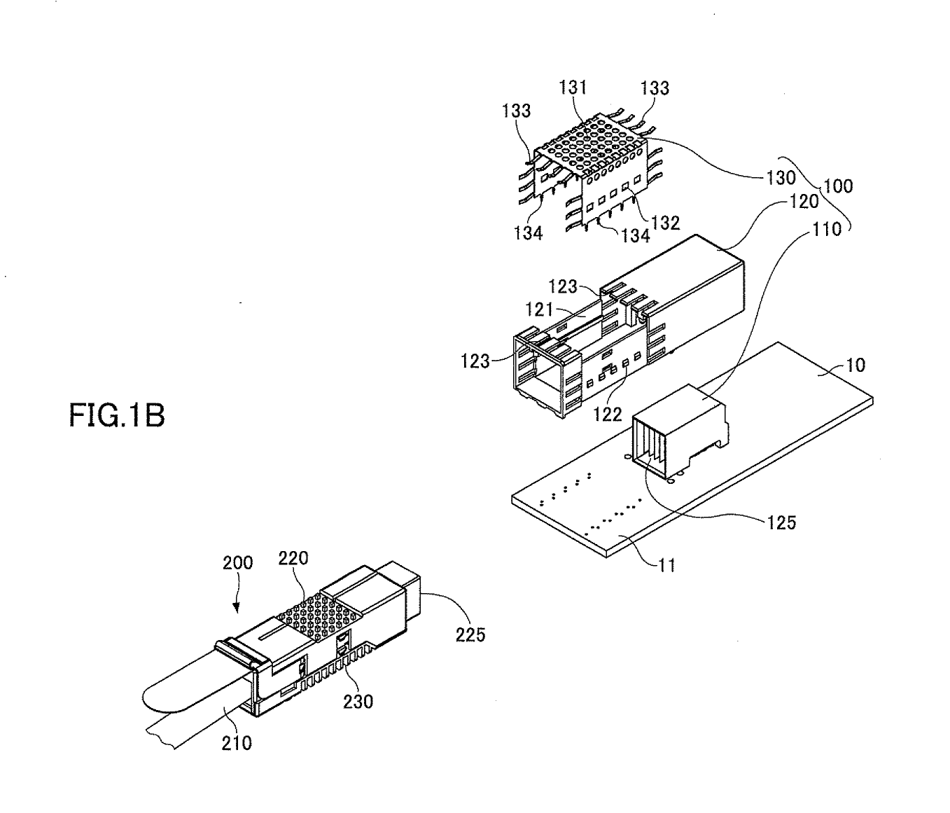

An electronic connector of the embodiment is described. As illustrated in FIG. 1, the electronic connector of the embodiment may be a first electronic connector 100 fixed to the board 10. By connecting a second connector (another connector) 200 to a first electronic connector body 110 of the first electronic connector 100, the first and second connectors 100 and 200 are electrically connected and a high-speed electric signal can be transmitted.

The first connector 100 includes a first electronic connector body 110 connected to the board 10, a cage 120 which can entirely cover the side surfaces of the first electronic connector body 110 and the side surfaces of the second connector 200 under a state where the first electronic connector body 110 and the second connector 200 are connected, and a pressure cover 130 attached to the cage 120.

The second electronic connector 200 is formed to be substantially in a rectangular parallelepiped shape. The second electronic connector 200 is connected to a cable 210 on a side opposite to a connecting face to the first electronic connector body 110 with the second electronic connector 200. A first radiator 220 and a second radiator 230 are provided on an upper surface and a bottom surface, respectively of the second electronic connector 200.

The first electronic connector body 110 includes connection terminals 125 electrically connected to connection terminals 225 provided in a housing of the second electronic connector 200. The first electronic connector body 110 is formed to be substantially in a rectangular parallelepiped shape, and is connected to the board 10 on one surface being the bottom surface of the six surfaces of the first electronic connector body 110. Specifically, signal terminals and a ground (GND) terminal (not illustrated) provided on the one surface being the bottom surface of the first electronic connector body 110 may be inserted into predetermined apertures provided in the board 10 and connected by soldering.

The first electronic connector body 110 is connected to the second electronic connector 200 on one side surface among four side surfaces of the connector body 110 if the surface connected to the board is called the bottom surface. Therefore, the second electronic connector 200 is connected to the board 10 after the second electronic connector 200 moves substantially in parallel to the board 10. Said differently, the second electronic connector 200 comes to mate with the connector body 110 of the first electronic connector 100 and therefore the second electronic connector 200 is electronically connected to the board 10.

The cage 120 shaped like a quadrangular prism is provided for EMI prevention and attached to the first electronic connector body 110. Since the cage 120 is formed by die-casting an alloy such as aluminum and zinc, the cage 120 has a sufficient thickness to prevent the cage 120 from being easily deformed. Likewise, the cage 120 does not loosen while the first electronic connector body 110 is being connected to the second electronic connector 200. The side surfaces of the first and second electronic connectors 100 and 200 are substantially covered when the first electronic connector body 110 is connected to the second electronic connector 200. The cage 120 has an opening 121 on its upper surface provided to accommodate (corresponding to) the first radiator 220 of the second electronic connector 200 while the first electronic connector body 110 is connected to the second electronic connector 200. Plural protrusions 122 are provided on the side surfaces and positioned where the opening 121 is provided in order to fix the pressure cover to the cage 120. On the top surface on which the opening 121 is formed and on two side surfaces of the cage 120 adjacent to the surface, plural grooves 123 extending in a connecting direction of the second electronic connector 200 to the first electronic connector body 110.

The pressure cover 130 is formed by processing a metallic plate. By bending the metallic plate, three faces are formed. The pressure cover 130 has plural louver holes for dissipating heat emitted from the first radiator 220 of the second electronic connector 200 when the first electronic connector body 110 is connected to the second electronic connector 200. The pressure cover 130 has plural fixing holes 132 provided at positions corresponding to positions provided by the plural protrusions 122 of the cage 120. By inserting the protrusions 122 of the cage 120 to the corresponding fixing holes 132 of the pressure cover 130, the pressure cover 130 is fixed to the cage 120.

The pressure cover 130 has plural springs 133 at positions corresponding to the grooves 123 of the cage 120. While the pressure cover 130 is fixed to the cage 120 and the cage 120 is attached to the first electronic connector body 110, the second electronic connector 200 is connected to the first electronic connector 100, the spring 133 may be in contact with the outside of the second electronic connector 200. Because the pressure cover 130 is grounded, the outside of the second electronic connector 200 which is in contact with the spring 133 of the pressure cover 130 also has the ground potential. Further, plural press fits 134 are formed on a bottom surface of the pressure cover 130 connected to the board and fixed to corresponding apertures 11 formed in the board 10.

With the embodiment, the cage 120 and the pressure cover 130 are provided. This structure is adopted to prevent the cage 120 from loosening while the first electronic connector body 110 is connected to the second electronic connector 200. For this, the cage 120 may be made by die-casting so as to have high strength. However, terminals such as the pressure fits 134 are not easily formed. Therefore, the pressure cover 130 is separately provided and the pressure cover 130 is fixed to the cage 120. The cage 120 is fixed to the board 10 by the pressure fits 134 of the pressure cover 130. Therefore, it is possible to fix the cage 120 to the board 10 without using screws.

### (Connection of Connectors)

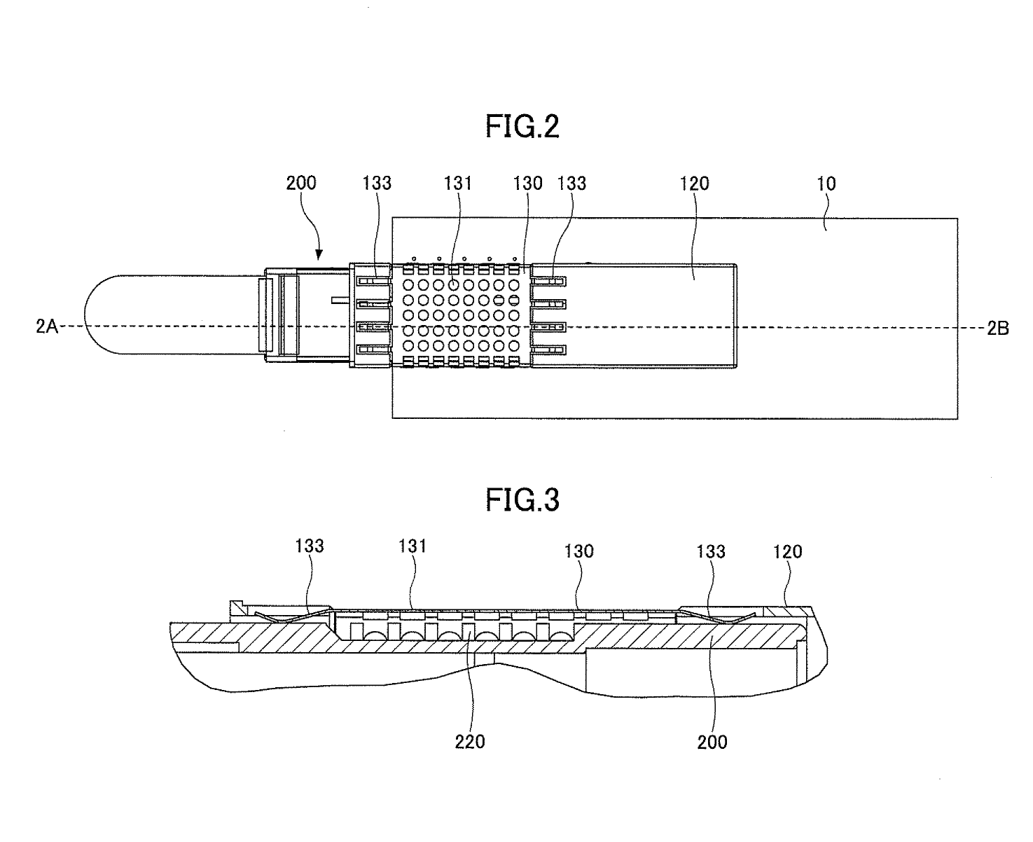

Referring to FIG. 2 and FIG. 3, the connection between the first electronic connector 100 and the second electronic connector 200 is described. FIG. 2 is a plan view of the first electronic connector 100 and the second electronic connector 200 which are connected to each other. FIG. 3 is a part of the cross-sectional view taken along the dash line 2B-2B of FIG. 2. While the first electronic connector 100 is connected to the second electronic connector 200, the outside of the second electronic connector 200 is in contact with the spring 133 of the pressure cover 130. Because the plural louver holes 131 are formed in the pressure cover 130 at positions corresponding to the position of the first radiator 220 of the second electronic connector 200, heat generated in the second connector 200 is efficiently dissipated.

### (Double-Side Mounting)

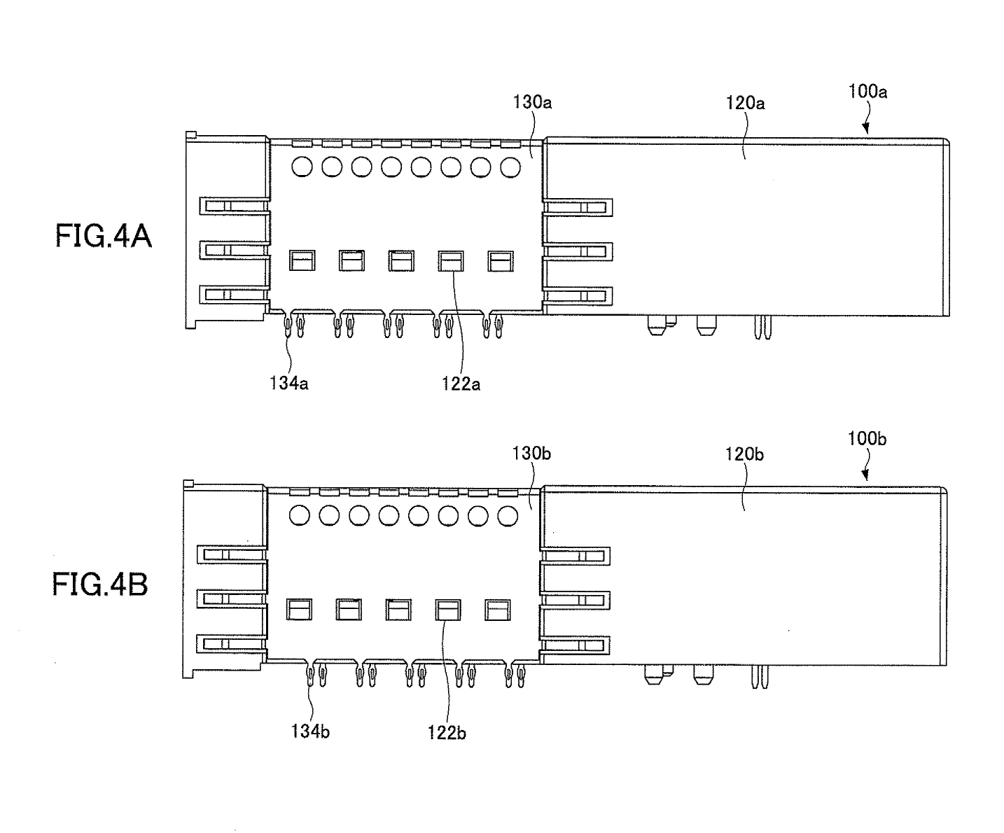

By attaching the first electronic connector 100 after rotating the position of the pressure cover 130 by 180° such that the positions of the front opened end and the back opened end are reversed, the arrangement of the right side and the left side of the pressure fits 134 being reversed relative to the board 10 can be changed. Therefore, a pair of first electronic connectors 100 can be mounted on the two surfaces of the board 10 as the double-side mounting. Specifically, a first connector 100a illustrated in FIG. 4A and a second connector 100b illustrated in FIG. 4B form a first electronic connector pair. However, the arrangement of the pressure fits 134a of the pressure cover 130a in the first connector 100a is different from the arrangement of the pressure fits 134b of the pressure cover 130b in the first connector 100b. For example, by attaching the pressure cover 130a after rotating the pressure cover 130a by 180′, the positions of the right side and the left side of the pressure fits 134 are reversed relative to the board 10. Thus, the arrangement of the pressure fits 134a can be changed to the arrangement of the pressure fits 134b. As such, by arranging the arrangement of the pressure fit 134 in a different way, the first connectors 100a and 100b are easily mounted on both surfaces of the board as the double-side mounting. When the pressure cover 130 is rotated by 180′, the positions of the pressure fits 134a of the pressure cover 130a do not interfere with the positions of the pressure fits 134b of the pressure cover 130b. Further, the pressure covers 130a and 130b have a bilaterally symmetric shape. Because the positions of the pressure fits 134a and 134b are not symmetric in the longitudinal direction of the pressure cover 130, the pressure fit 134a can be attached to the cage 120 after rotating the pressure cover 130a by 180°. Likewise, the pressure cover 130b can be rotated in a similar manner to the pressure cover 130a.

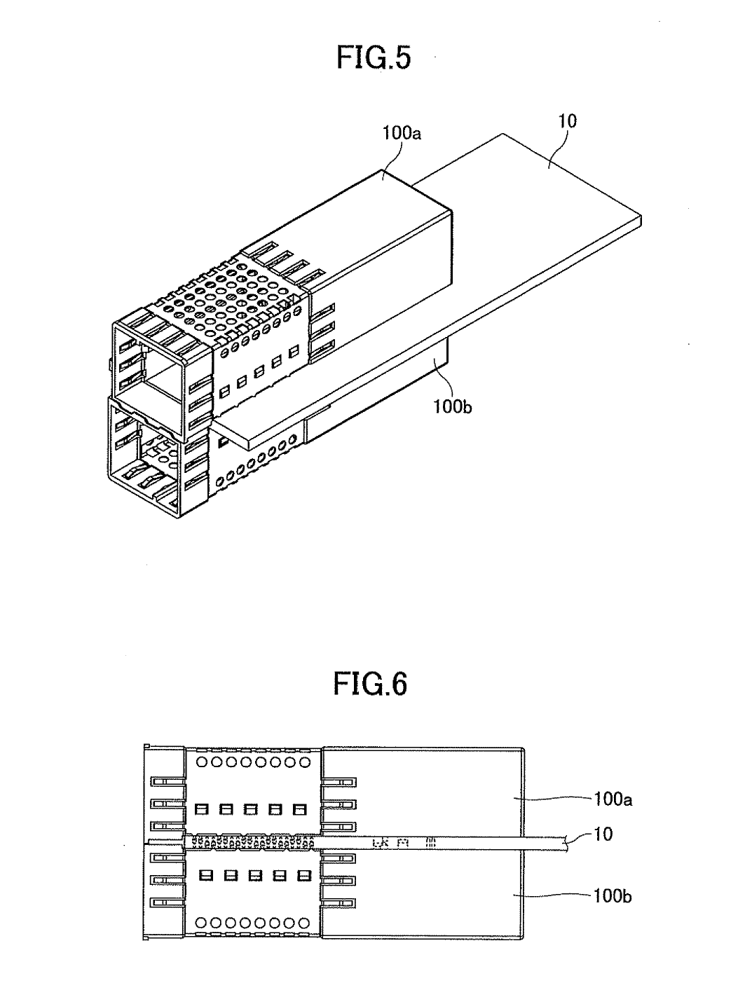

Referring to FIG. 5 and FIG. 6, the first connectors 100a and 100b attached to both surfaces of the board 10 are explained. As described, without overlapping the positions of the pressure fits 134a and 134b inserted into the board 10, the first electronic connector 100a is attached to the one surface of the board 10 and the first electronic connector 100b is attached to the other surface of the board 10. Thus, the first electronic connectors 100a and 100b are highly densely mounted on the board 10.

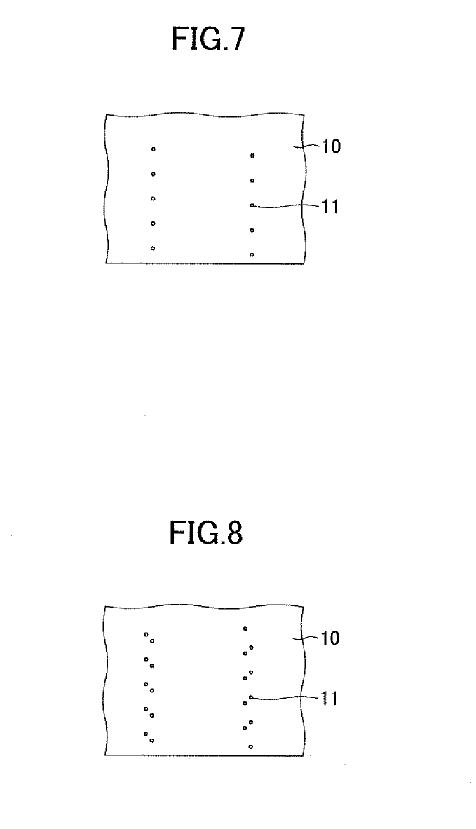

Referring to FIG. 7, apertures 11 used in mounting the first electronic connector 100a on a single surface of the board 10 are illustrated. Referring to FIG. 8, apertures 11 used in mounting the first electronic connectors 100a and 100b on both surfaces (double sides) of the board 10 are illustrated. Referring to FIG. 7 and FIG. 8, the board 10 has the apertures 11 at positions corresponding to the pressure fits 134a of the pressure cover 130a of the first electronic connector 100a and the pressure fits 134b of the pressure cover 130b of the first electronic connector 100b. As described, by providing the apertures 11 at the corresponding positions of the board 10, the first electronic connectors 100a and 100b are mounted on both surfaces (double sides) of the board 10.

As described, with the embodiment, the connectors are stably connected without loosening the cage when the connectors are connected and the connectors are highly integrated on the board.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic connector comprising:
a connector body which is fixed to a board and is configured to be connected to another connector;
a cage which is formed by die-casting a metal and shaped to cover entire side surfaces of the connector body and the other connector; and
a pressure cover which includes fixed terminals for fixing the pressure cover to the board,
wherein the pressure cover is connected to the cage, and the cage is connected to the board by the fixed terminals of the pressure cover.

2. The electronic connector according to claim 1,
wherein the cage has an opening at a position corresponding to a heat dissipating portion of the other connector,
the pressure cover is shaped to cover the opening of the cage, and
the pressure cover includes louver holes for dissipating heat from the other connector.

3. The electronic connector according to claim 1,
wherein the pressure cover is formed by processing a metallic plate, and
the fixed terminals are pressure fits.

4. The electronic connector according to claim 1,
wherein a plurality of protrusions are formed on both surfaces of the cage,
the pressure cover includes a plurality of fixing holes at positions corresponding to the protrusions, and
the cage and the pressure cover are connected by inserting the protrusions into the fixing holes.

5. The electronic connector according to claim 1,
wherein the pressure cover includes springs configured to be in contact with the other connector in grooves formed in the cage.

6. The electronic connector according to claim 1,
wherein the pressure cover is bent to be formed in a U-shape, and
a position of the pressure cover is interchangeable such that if the pressure cover is rotated by 180° in parallel to the board the arrangement of the fixed terminals change relative to the cage.

7. The electronic connector according to claim 6,
wherein a number of the electronic connector is two, one of the electronic connectors is mounted on one of two surfaces of the board, and another one of the electronic connectors is mounted on another one of the two surfaces of the board.

8. An electronic connector set comprising:
a first electronic connector including:
a connector body which is fixed to a board;
a cage which is formed by die-casting a metal and shaped to cover entire side surfaces of the connector body; and
a pressure cover which includes fixed terminals for fixing the pressure cover to the board; and
a second electronic connector configured to be connected to the connector body of the first electronic connector and to be covered by the first pressure cover of the first electronic connector,
wherein the pressure cover is connected to the cage, and
the cage is connected to the board by the fixed terminals of the pressure cover.

9. The electronic connector set according to claim 8,
wherein the cage has an opening at a position corresponding to a heat dissipating portion of the second connector,
the pressure cover is shaped to cover the opening of the cage, and
the pressure cover includes louver holes for dissipating heat from the second connector.

10. The electronic connector set according to claim 8,
wherein the pressure cover is formed by processing a metallic plate, and
the fixed terminals are pressure fits.

11. The electronic connector set according to claim 8,
wherein a plurality of protrusions are formed on both surfaces of the cage,
the pressure cover includes a plurality of fixing holes at positions corresponding to the protrusions, and
the cage and the pressure cover are connected by inserting the protrusions into the fixing holes.

12. The electronic connector according to claim 8,
wherein the pressure cover includes springs configured to be in contact with the second connector in grooves formed in the cage.

13. The electronic connector set according to claim 8,
wherein the pressure cover is bent to be formed in a U-shape, and
a position of the pressure cover is interchangeable such that if the pressure cover is rotated by 180° in parallel to the board the arrangement of the fixed terminals change relative to the cage.

14. The electronic connector set according to claim 13,
wherein a number of the electronic connector set is two, one of the electronic connector sets is mounted on one of two surfaces of the board, and another one of the electronic connector sets is mounted on another one of the two surfaces of the board.
